(19) United States
(12) Patent Application Publication
(10) Pub. No.: US 2025/0135668 A1
(43) Pub. Date: May 1, 2025

(54) HAIR CLIPPER HAVING BLADE OFFSET ADJUSTMENT

(71) Applicant: WAHL CLIPPER CORPORATION, Sterling, IL (US)

(72) Inventors: Gary Lee SNOW, Rock Falls, IL (US); Eric John FISHER, Rock Falls, IL (US)

(21) Appl. No.: 18/498,948

(22) Filed: Oct. 31, 2023

(51) Int. Cl. B26B 19/20; B26B 19/06; B26B 19/38

(52) U.S. Cl. CPC B26B 19/205; B26B 19/06; B26B 19/3846; B26B 19/3886

(57) ABSTRACT

An adjustable bladeset for a hair clipper with a clipper housing includes a stationary blade having a stationary toothed end with a plurality of stationary teeth, an opposite stationary base end and an upper surface, and a moving blade having a moving toothed end with a plurality of moving teeth, the moving blade configured for reciprocal transverse movement relative to the stationary blade on the upper surface. The stationary blade is linearly displaceable relative to the moving blade by action of an adjustment lever on the clipper housing. A blade guide is on the upper surface at the stationary base end, and has at least one toothed strip. The adjustment lever is connected to a blade actuator shaft having at least one toothed cog configured to engage the toothed strip so that rotation of the actuator shaft causes the linear displacement of the stationary blade relative to the moving blade.

### BACKGROUND

The present invention relates generally to electric hair clippers and trimmers, collectively referred to as hair clippers, and more specifically to an improved operator-powered feature for the adjustment of the clipper blade offset between respective tips of the moving and stationary blades.

Electric hair clippers are well known in the art, and feature an electric motor powering a moving blade of a bladeset in a laterally reciprocating manner in relation to a stationary blade. Both the moving blade and the stationary blade have teeth, and both blades are collectively referred to as the clipper bladeset. Hair caught between the teeth of the blades is sheared through movement of the moving blade relative to the fixed blade.

Conventional hair clippers are often provided with an adjustment lever associated with the bladeset that is used for adjusting the relative position between tips of the moving blade teeth relative to tips of the stationary blade teeth. Suitable blade adjustment mechanisms are described in commonly-assigned U.S. Pat. Nos. 3,093,901 and 9,545,729 which are incorporated by reference. In a general mode of operation, where standard hair clipping is concerned, the tips of the stationary blade are adjusted to project beyond or in front of tips of the corresponding moving blade teeth. This position creates a clearance between the stationary blade teeth and the moving blade teeth that protects the subject's scalp from being pinched or nicked during the clipping operation.

However, when a sharper cut is desired, such as when outlining the hairline, for example around the subject's neck or near side burns, the operator often adjusts the stationary blade so that the tips of both blade teeth are closely aligned, to the point where the tips of both sets of teeth are aligned on a vertical axis. This adjustment is achieved by the operator moving a lever on the side of the clipper bladeset. In most conventional hair clippers with this feature, the mechanism is constructed and arranged so that once a lever position is selected, the adjustment holds during operation without further action by the operator.

The travel of the stationary blade from a fully retracted to a fully extended position is not very great, approximately 0.040 inch. In conventional hair clippers, the required movement is achieved by using a cam or a key on a transverse shaft connected to the adjustment lever. The lever is configured so that movement of the lever forward or backward causes rotation of the shaft, and the cam or key, which is engaged in a corresponding slot on the stationary blade or an associated adjustment plate. Such movement of the lever causes the desired movement of the stationary blade forward or rearward relative to the moving blade. In conventional hair clippers, spring washers or the like are used to create sufficient friction on the shaft and lever mechanism to maintain the desired position of the adjustment lever and the associated transverse shaft during clipper operation.

While many conventional hair clippers are equipped with such adjustment levers that operate using a smooth or infinite number of adjustments, there is also a group of operators that desires a series of preset stationary blade adjustment positions, preferably with a tactile feedback to the operator of indexed lever movement. Clipper manufacturers have been hesitant to manufacture hair clippers with preset positions for fear of alienating those operators who prefer the conventional smooth operation. Converting conventional clippers with a smooth adjustment lever operation to a plurality of preset adjustment positions or indexed positions, entails significant design and manufacturing retooling, and as such manufacturers have been hesitant to address the desires of this group of operators.

Accordingly, there is a need for an improved electric hair clipper which addresses the preferences of both of the above-identified groups of operators regarding the type of blade adjustment mechanism.

### SUMMARY

The above-listed need is met or exceeded by the present hair clipper having a blade offset adjustment featuring a rack and pinion arrangement with a rack in the form of one or more toothed strips located on a blade guide secured to an upper surface of the stationary blade. Preferably, the rack includes a pair of generally parallel rows of toothed strips projecting in a direction transverse to the direction of motion of the moving blade relative to the stationary blade. A stationary, yet rotatable blade actuator shaft is oriented transverse to the toothed strips, and features a pair of spaced toothed cogs, each positioned for engaging a corresponding one of the toothed racks.

A blade adjustment lever is connected to the blade actuator shaft so that movement of the shaft forward or backward relative to a clipper housing causes the cogs to rotatably engage the toothed strips, thus moving the stationary blade forwards or backwards as desired. The use of the rack and pinion provides for relatively more precise adjustment of the position of the stationary blade as opposed to more conventional designs, including those described above.

Another feature of the present clipper is that the adjustment lever is connected to the above-described blade adjustment linkage in a manner that permits operator selection of the movement of the adjustment lever between a conventional, smooth movement, and an indexed, tactile or ratcheted movement. A selector knob on the adjustment lever includes a selector ring that rotates between two positions, a locked position, causing smooth lever movement, and an unlocked position causing indexed lever movement.

The adjustment lever is connected to the selector knob that is provided with a splined shaft that engages a splined bore in the blade actuator shaft. A toothed ring has a splined throughbore to slide along the splined shaft, and is biased towards the bladeset by a biasing member, preferably a helical spring. In axial alignment with the splined shaft and the toothed ring, a gear bushing is fixed to the clipper housing at the bladeset and has a toothed face that engages corresponding teeth on the toothed ring. The selector ring on the selector knob is configured with a cam and has fingers projecting along the splined shaft that grasp a radially extending flange on the toothed ring.

As such, rotation of the selector ring relative to the knob, which is also relative to the adjustment lever, between the locked and unlocked positions causes movement of the toothed ring along the splined shaft. In the locked, smooth adjustment position, the fingers pull the toothed ring backwards out of engagement with the gear bushing, overcoming the force of the helical spring, and are locked in that position. Since the toothed ring is held out of engagement with the teeth of the gear bushing, this position achieves smooth motion of the adjustment lever.

As the selector ring on the selector knob is rotated, due to cam action inside the selector knob, the fingers move down the splined shaft in the direction of the blades, and place the toothed ring in biased engagement with the teeth of the gear bushing. Since the gear bushing is fixed to the clipper housing, movement of the selector lever rotates the splined shaft, and thus causes the toothed ring, which moves with the splined shaft, and is also now biased into engagement with the gear bushing, to skip over the teeth of the gear bushing, causing a tactile clicking or indexed movement of the adjustment lever.

More specifically, an adjustable bladeset for a hair clipper having a clipper housing includes a stationary blade having a stationary toothed end with a plurality of stationary teeth, an opposite stationary base end and an upper surface, and a moving blade having a moving toothed end with a plurality of moving teeth, the moving blade configured for reciprocal transverse movement relative to the stationary blade on the upper surface. The stationary blade is linearly displaceable relative to the moving blade by action of an adjustment lever associated with the clipper housing. A blade guide is associated with the upper surface and is located on the stationary base end, the blade guide having at least one toothed strip. The adjustment lever is connected to a blade actuator shaft having at least one toothed cog configured to engage the toothed strip so that rotation of the actuator shaft causes the linear displacement of the stationary blade relative to the moving blade.

Preferably, rotation of the actuator shaft between a locked and an unlocked position causes movement of the stationary blade from an extended position to a retracted position.

In an embodiment, the blade guide has a pair of the toothed strips in spaced parallel relationship, and the actuator shaft has a pair of the toothed cogs, each cog arranged to engage an associated one of the toothed strips. In an embodiment, the adjustment lever is connected to the blade actuator shaft for common rotation. In a preferred embodiment, the adjustment lever is provided with a selector knob configured for rotating between two positions, a locked position causing smooth lever movement, and an unlocked position causing indexed lever movement.

In the latter embodiment, the selector knob has a splined shaft projecting from the knob and engaging a splined bore on the actuator shaft, and a toothed ring associated with the knob has a splined bore for slidably engaging the splined shaft. Preferably the selector knob has a biasing member that biases the toothed ring on the splined shaft away from the selector knob and from a handle on the adjustment lever.

In an embodiment, the selector knob has a selector ring, a cam and at least one finger projecting from the cam along the splined shaft, each finger being configured for grasping the toothed ring so that the biasing member is held between the toothed ring and the selector knob. In an embodiment, the toothed ring has a radially enlarged flange configured for accommodating tips of each finger. Preferably, the selector knob is associated with the adjustment lever so that rotation of the selector ring on the selector knob relative to the adjustment lever between the locked and unlocked positions causes movement of the toothed ring along the splined shaft, in the locked position, the fingers pull the toothed ring towards the adjustment lever, overcoming the force of the helical spring, thus achieving smooth motion of the adjustment lever. As the selector knob is rotated to the unlocked position, the fingers move down the splined shaft away from the adjustment lever, and place the toothed ring in biased engagement with a toothed gear bushing fixed to the clipper housing, causing a tactile clicking or indexed movement of the adjustment lever.

In another embodiment, an adjustable bladeset for a hair clipper having a clipper housing includes a stationary blade having a stationary toothed end with a plurality of stationary teeth, an opposite stationary base end and an upper surface, and a moving blade having a moving toothed end with a plurality of moving teeth, the moving blade configured for reciprocal transverse movement relative to the stationary blade on the upper surface. The stationary blade is linearly displaceable relative to the moving blade by action of an adjustment lever associated with the clipper housing. The adjustment lever is provided with a selector knob with a selector ring configured for rotating between two positions, a locked position causing smooth lever movement, and an unlocked position causing indexed lever movement.

In yet another embodiment, a hair clipper is provided, including a clipper housing, and a clipper bladeset including a stationary blade having a stationary toothed end with a plurality of stationary teeth, an opposite stationary base end and an upper surface, and a moving blade having a moving toothed end with a plurality of moving teeth, the moving blade configured for reciprocal transverse movement relative to the stationary blade on the upper surface, the stationary blade being linearly displaceable relative to the moving blade by action of an adjustment lever associated with the clipper housing. The adjustment lever is provided with a selector knob configured for rotating between two positions, a locked position causing smooth lever movement, and an unlocked position causing indexed lever movement.

In an embodiment, a blade guide is associated with the upper surface and is located on the stationary base end, the blade guide having at least one toothed strip. Preferably, the adjustment lever is connected to a blade actuator shaft having at least one toothed cog configured to engage the toothed strip so that rotation of the actuator shaft causes the linear displacement of the stationary blade relative to the moving blade.

### BRIEF DESCRIPTION OF THE DRAWINGS

FIG. 1 is a top perspective view of the present hair clipper;

FIG. 2 is a top front perspective view of the present bladeset with blade adjustment lever;

FIG. 3 is a top rear perspective view of the bladeset of FIG. 2;

FIG. 4 is an exploded front perspective view of the bladeset of FIG. 2;

FIG. 5 is a top perspective view of the present blade guide with the rack;

FIG. 6 is a partially cut-away front perspective view of the clipper of FIG. 1;

FIG. 7 is an exploded front perspective view of the adjustment lever and related components;

FIG. 8 is a perspective view of the present selector knob and fingers;

FIG. 9 is a perspective view of the present toothed ring;

FIG. 10 is an inner perspective view of the adjustment lever;

FIG. 11 is another inner perspective view of the adjustment lever with assembled toothed ring and splined shaft;

FIG. 12 is a perspective view of the gear bushing;

FIG. 13 is a fragmentary front perspective view of the present clipper showing the selector knob assembly;

FIG. 14 is a fragmentary cross-section of the selector knob and stationary blade actuator shaft with the selector knob in the indexed position;

FIG. 15 is another fragmentary cross-section of the selector knob and stationary blade actuator shaft with the selector knob in the smooth position; and

FIG. 16 is a fragmentary inner view of the present adjustment lever assembly.

### DETAILED DESCRIPTION

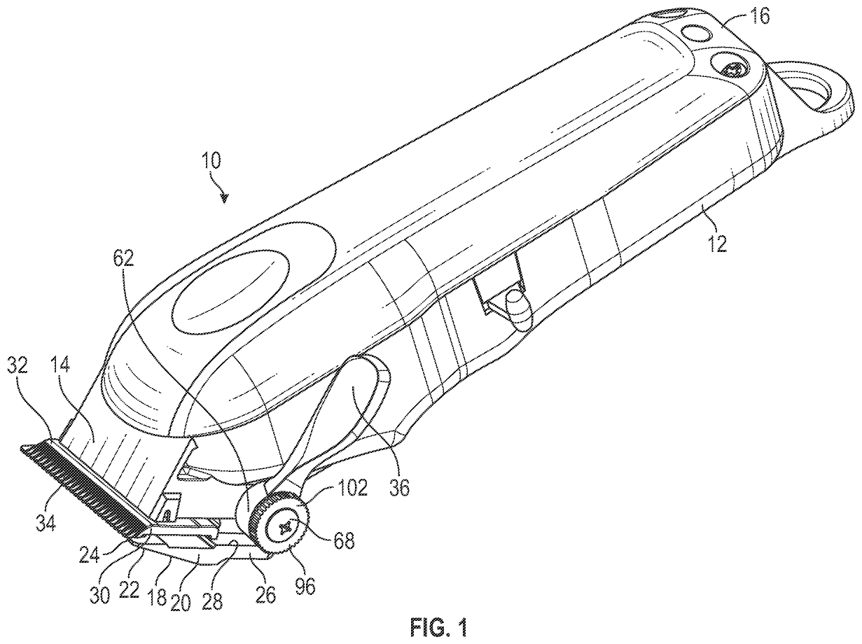

Referring now to FIGS. 1-3, an electric hair clipper is generally designated 10 and includes a clipper housing 12 with a drive end 14 and a rear end 16. As is common in the industry, the present housing 12 is made up of opposing clamshell halves which house a motor, power transmission system, circuitry and a battery or line cord connections, all not shown. A clipper bladeset 18 is constructed and arranged for releasable mounting to the drive end 14 of the housing.

Included on the bladeset 18 is a stationary blade 20 having a stationary toothed end 22 with a plurality of stationary teeth 24, an opposite stationary base end 26 and an upper surface 28. Also included on the bladeset 18 is a moving blade 30 having a moving toothed end 32 with a plurality of moving teeth 34. Preferably, the moving blade is configured for reciprocal transverse movement relative to the stationary blade 20, with the movement of the moving blade 30 being across the upper surface 28. The bladeset 18 is also configured so that the stationary blade 20 is linearly displaceable relative to the moving blade 30 by action of an adjustment lever 36 associated with the clipper housing 12. In the present application “linearly displaceable” refers to movement of the stationary blade 20 in a direction parallel to a longitudinal axis of the clipper housing 12, and transverse to the direction of movement of the moving blade 30 relative to the stationary blade. The bladeset 18 is attachable as a unit to the drive end 14 of the clipper housing 12 using threaded fasteners or the like.

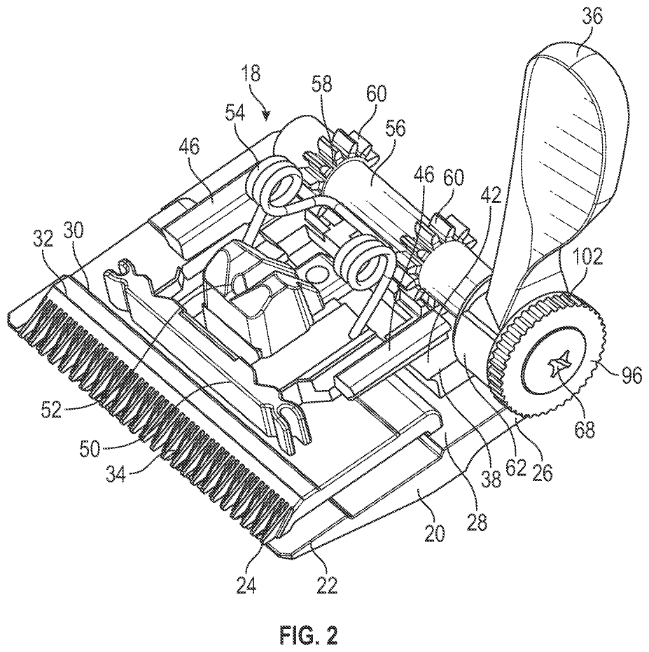

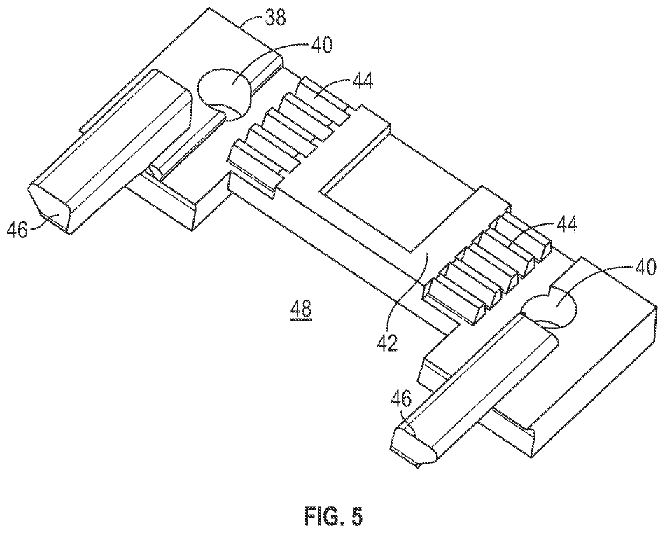

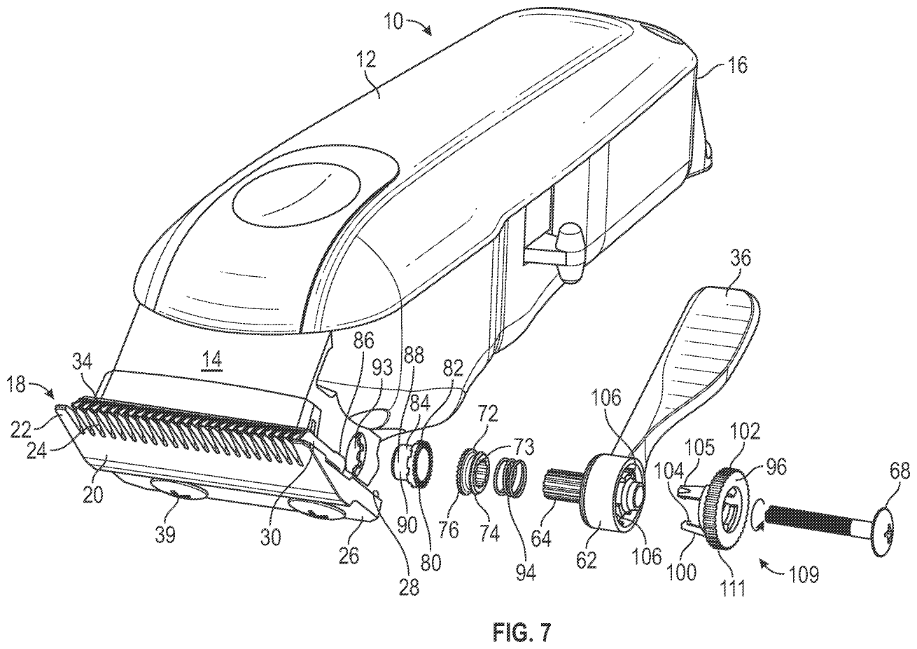

Referring now to FIGS. 2-5, also included on the bladeset 18 is a blade guide 38 associated with the upper surface 28 of the stationary blade 20 and located on the stationary base end 26. While other shapes are contemplated, in the preferred embodiment, the blade guide 38 has a generally flattened block shape and is located behind, or closer to the clipper housing 12 than the moving blade 30. At least one mounting aperture 40 on the blade guide 38 accommodates a threaded fastener 39 (FIG. 7) used to secure the bladeset 18 to the clipper housing 12. Also, the blade guide 38 has an upper surface 42 with at least one toothed strip or rack 44 extending in the linear direction. Preferably, a pair of the toothed strips 44 are disposed on the blade guide in spaced, parallel orientation (FIG. 5).

A pair of forwardly extending bars 46 extend from the blade guide 38 and define a transverse travel space 48 for a cam follower 50. The cam follower 50 is configured for positively engaging the moving blade 30 for common movement, and has a vertically-projecting cam seat 52 configured for accommodating a drive cam (not shown) portion of the clipper power transmission system. A biasing element 54 such as a coiled spring is associated with the bladeset 18 and biases the cam follower 50 and the moving blade 30 against the stationary blade 20.

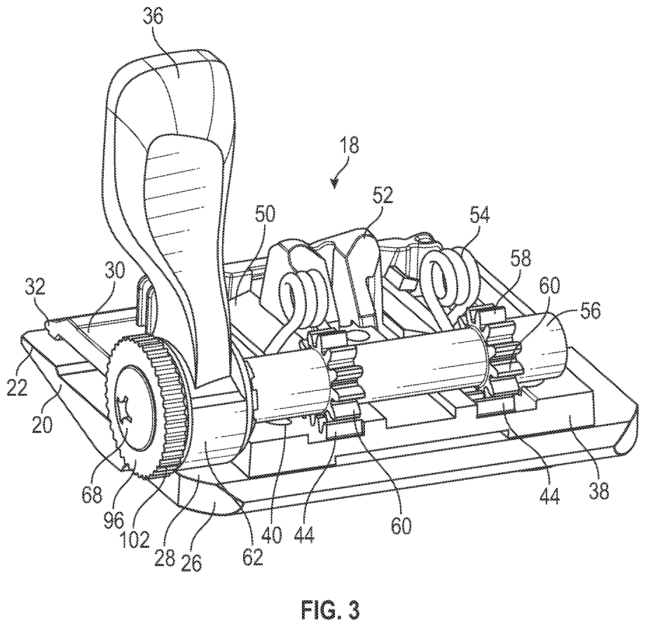

As seen in FIGS. 2 and 3, the adjustment lever 36 is connected to a blade actuator shaft 56 having at least one toothed cog or pinion 58, each cog having a plurality of radially outwardly extending teeth 60. The teeth 60 on each cog 58 are configured for engaging the corresponding toothed strip 44 so that rotation of the actuator shaft 56, controlled by the adjustment lever 36, causes the previously described linear displacement of the stationary blade 20 relative to the moving blade 30. Movement of the adjustment lever 36 causes rotation of the actuator shaft 56 between a locked position and an unlocked position that in turn causes movement of the stationary blade 20 between an extended position and a retracted position. As described above, the full travel distance of the stationary blade 20 relative to the moving blade 30 is about 0.040 inch, so the positioning of the stationary blade 20 by the operator is achievable with only partial rotation of the actuator shaft 56.

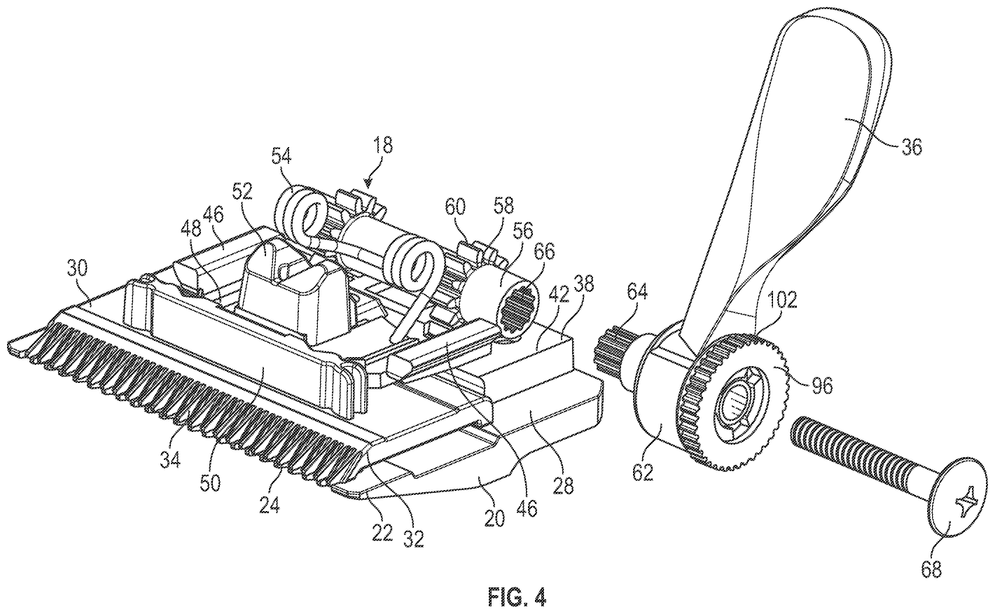

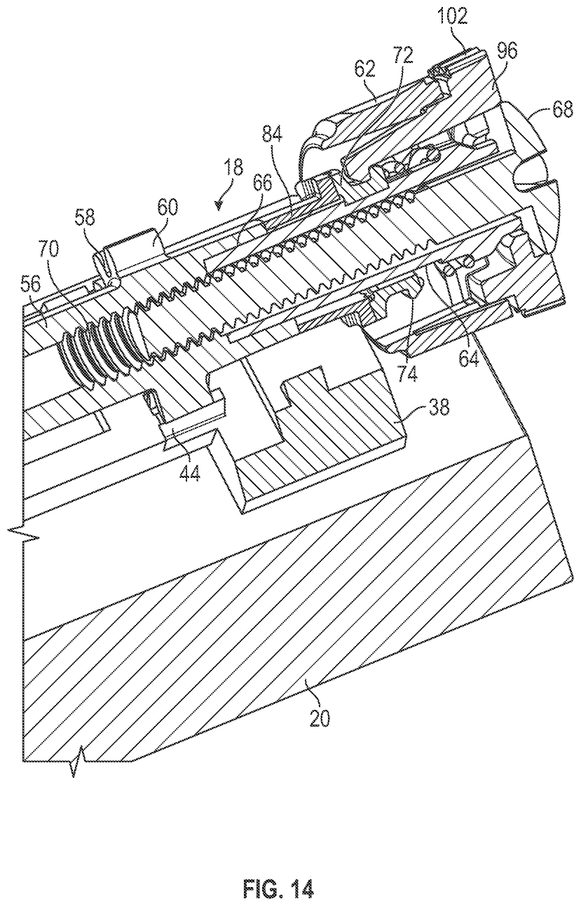

Referring now to FIG. 4, the adjustment lever 36 is connected to a selector knob 62 provided with a transversely-projecting splined end or splined shaft 64 configured for positively engaging a splined bore 66 in the actuator shaft 56 so that engagement of the selector knob 62 on the actuator shaft ensures common movement. In the preferred embodiment, the selector knob 62 is actually a portion of the adjustment lever 36 and houses several components described below that provide the operator with the choice of smooth or tactile/indexed motion. A threaded fastener 68 secures the selector knob 62 and the adjustment lever 36 to the actuator shaft 56 by engaging internal threads 70 on the actuator shaft (FIG. 14).

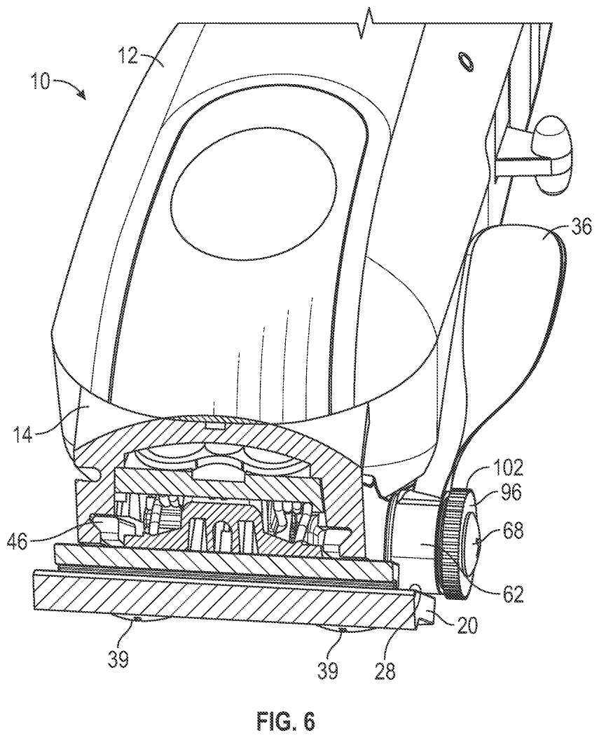

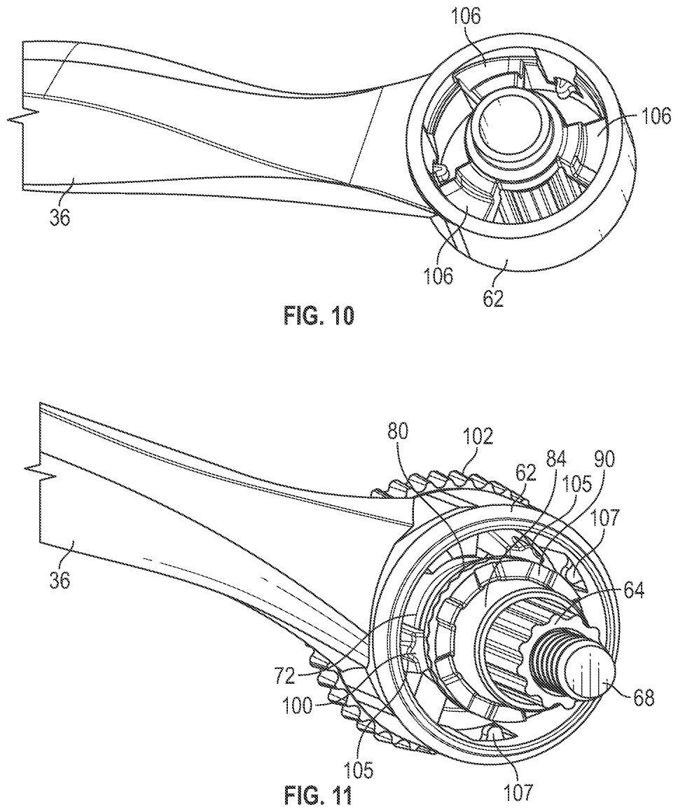

Referring now to FIGS. 6-16, a feature of the present hair clipper 10 and the bladeset 18 is that the selector knob 62 includes components configured for rotating between two positions, a locked position causing smooth adjustment lever movement, and an unlocked position causing indexed adjustment lever movement. As seen in FIG. 7, the splined end 64 of the selector knob 62 is sufficiently long to not only engage the actuator shaft as described above, but also to define a travel distance for a toothed ring 72 which has an internal splined bore 73 dimensioned for slidable engagement along the splined end 64. In addition, the toothed ring 72 is provided with a radially enlarged flange 74 at an end closer to the selector knob 62, and a toothed face 76 at an opposite end closer to the blade actuator shaft 56. The toothed face 76 includes a vertically arranged ring of laterally-projecting teeth 78 configured in the manner of a ring gear (FIG. 9).

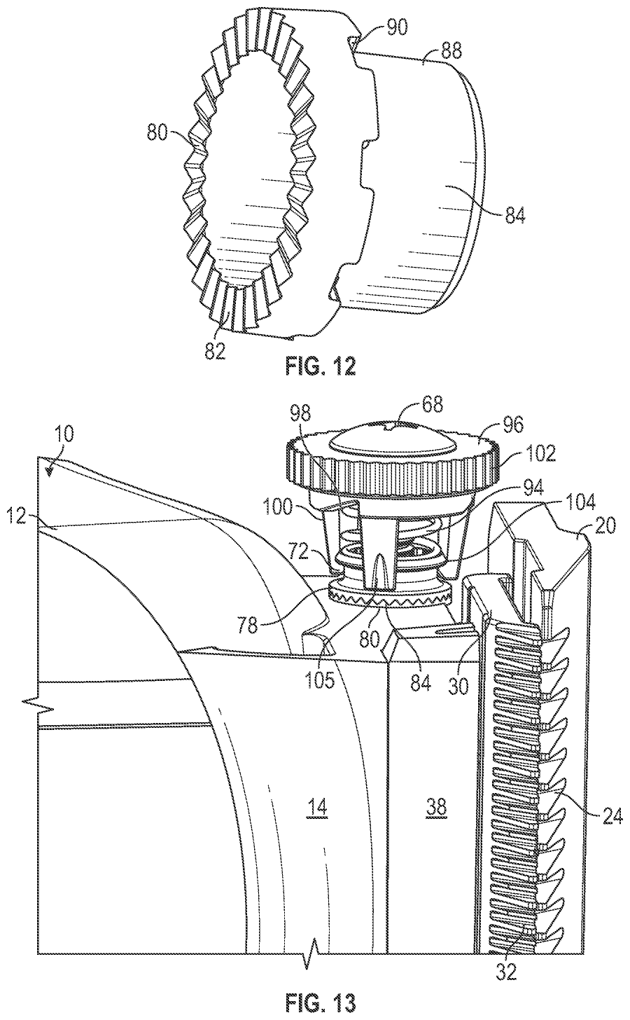

The teeth 78 are constructed and arranged to periodically engage a similar plurality of bushing teeth 80 located on a toothed face 82 of a gear bushing 84. To fix the gear bushing 84 in a bore 86 in the housing 12, the gear bushing 84 is provided with a boss 88 and a castellated surface 90 opposite the toothed face 82. Complementary castellations 92 are formed in the bore 86 for accommodating the castellated surface 90 and holding the gear bushing in place in the housing 12 (FIGS. 7 and 12).

A biasing member 94, preferably a helical spring, surrounds the splined shaft 64 and is disposed between the selector knob 62 and the toothed ring 72 so that upon assembly of the hair clipper 10, the toothed ring 72 is biased away from the selector knob 62 and against the gear bushing 84 (see in particular FIG. 14). This biasing force urges the respective teeth 78 of the toothed ring 72 into engagement with the bushing teeth 80. Since the toothed ring 72 moves with the splined end or shaft 64 and also with the adjustment lever 36, the engagement of the corresponding opposed sets of teeth 78, 80 will create a tactile indexed or ratcheting sensation for the operator moving the adjustment lever for adjusting the position of the stationary blade 20 relative to the moving blade 30.

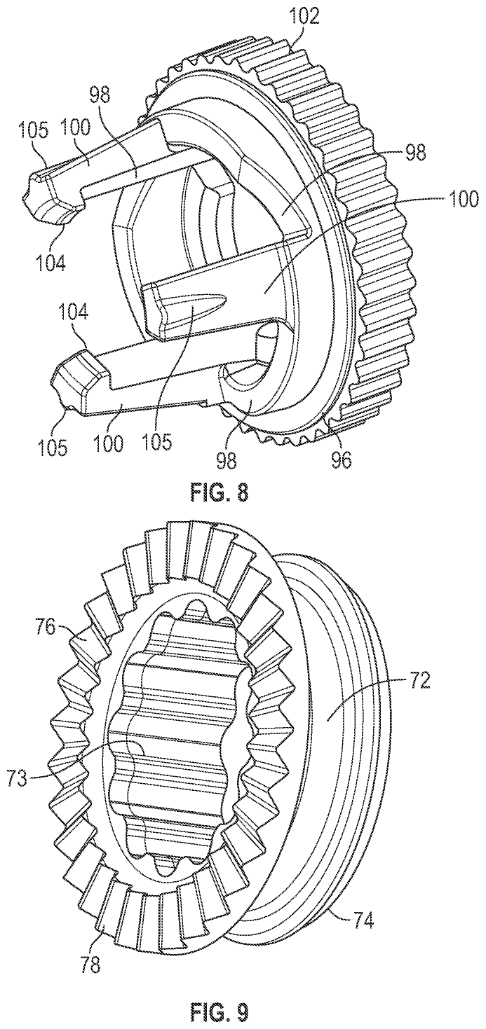

Referring now to FIGS. 4 and 8, also included in the selector knob 62 is a selector ring 96 rotatably engageable in the knob 62 and having one or more vertically arranged helical cam surfaces or ramps 98 and at least one finger 100 projecting from the cam along and parallel to the splined shaft 64. In the illustrated embodiment, it will be noted that there are three ramps 98 arranged symmetrically about selector ring 96. It is contemplated by the teachings herein that a single ramp 98 is sufficient, however. An external, annular surface 102 on the selector ring 96 enhances operator grip in rotating the selector ring 96 relative to the knob 62. It is contemplated herein that surface 102 may be smooth, or may include any other texture, e.g. knurling, that would enhance user manipulation thereof. Each finger 100 is configured for grasping the toothed ring 72, more specifically the enlarged flange 74 so that the movement of the toothed ring 72 is controlled along the splined shaft 64, and the biasing member 94 is held between the toothed ring and the selector knob 62. Preferably, each finger 100 has a hook tip 104 for more positively engaging the flange 74, and an external locating rib 105 for engaging a corresponding rib 107 (see FIG. 11) located on an interior surface of the selector knob 62.

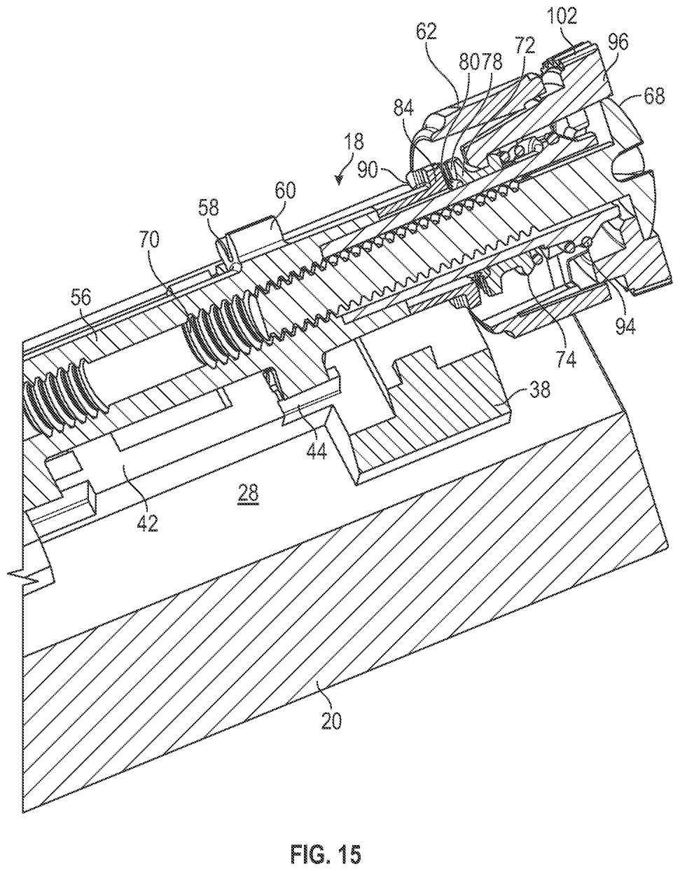

Referring to FIG. 7, the selector ring 96 is rotatable relative to the selector knob 62 in rotational directions 109, 111. As will be described in greater detail below, rotation of the selector ring 96 in rotational direction 109 will place selector ring 96 in the position shown in FIG. 14, also referred to herein as the unlocked position. Rotation of the selector ring 96 in rotational direction 111 will place selector ring 96 in the position shown in FIG. 15, also referred to herein as the locked position.

Referring now to FIG. 14, in the unlocked position, toothed ring 72 has moved along splined shaft 64 such that teeth 78 are engaged with teeth 80 of bushing 84. Because bushing 84 is fixed relative to the housing and the toothed ring 72 rotates with rotation of selector knob 62, rotation of selector knob 62 results in an audible clicking noise as teeth 78 move relative to teeth 80. Biasing member 94 returns and maintains surface contact between teeth 78, 80.

Referring now to FIG. 15, in the locked position toothed ring 72 has been moved along splined shaft 64 such that teeth 78 are no longer engaged with teeth 80 of bushing 84. This results in smooth rotation of selector knob 62, i.e. there is no audible clicking noise. Accordingly, the user is allowed to preferentially select whether selector knob clicks, or does not click, by placing selector ring 96 in the unlocked or locked positions, respectively.

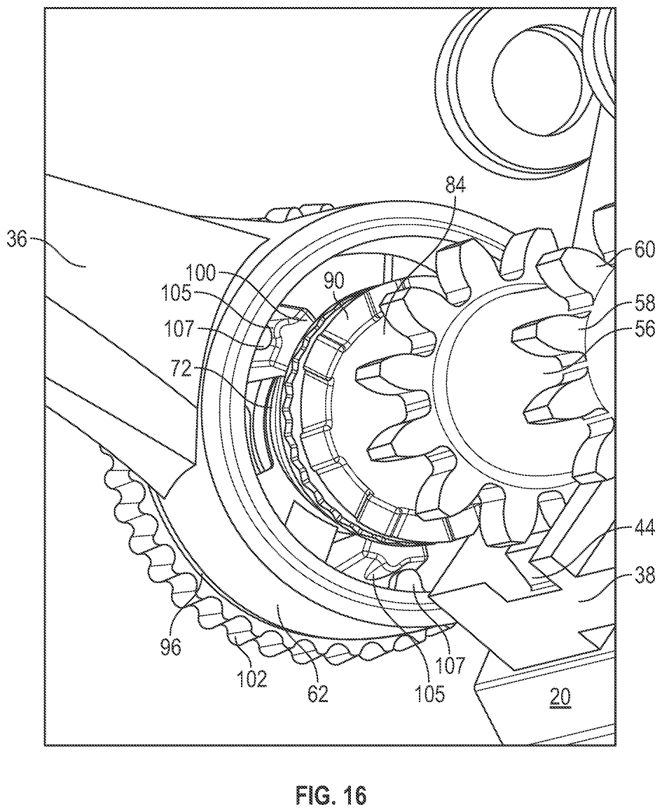

Referring now to FIG. 16, in the locked position (i.e. after rotation in rotational direction 111), the locating ribs 105 of the selector ring 96 are rotated past the corresponding ribs 107 of the selector knob 62. This configuration prevents the selector ring 96 from rotating back to an unlocked position as is shown in FIG. 14. In other words, the locking arrangement between locating ribs 105 and corresponding ribs 107 prevents inadvertent movement of selector ring 96 once fully rotated in rotational direction 111. To transition from the locked position to the unlocked position, locating ribs 105 will shift radially inward upon rotation in rotational direction 109 under sufficient torque provided by the user. This results in locating ribs 105 being able to rotate past corresponding ribs 107 in a resilient detent style motion.

Referring now to FIGS. 4, 7, 8 and 15, the ramps 98 on the selector ring 96 are in surface contact with corresponding ramps 106 in the selector knob 62 so that rotation of the selector ring 96 relative to the selector knob 62 will cause axial displacement of the fingers 100 along the splined shaft 64. As was the case with the ramps 98, although three ramps 106 are depicted in the illustrated embodiment, a single ramp 106 would be sufficient. It is only necessary that one of the ramps 98 of selector ring 96 be in contact with one of the ramps 106 of the selector knob 62 to achieve the camming action described herein.

Referring now to FIGS. 6 and 13-15, it will be seen that the threaded fastener 68 engages the threads 70 inside the actuator shaft and thus secures the assembly of the adjustment lever 36 and the selector knob 62, including the selector ring 96, the biasing member 94 and the toothed ring 72. Such assembly securely retains the adjustment lever 36, but permits rotation of the lever for achieving movement of the stationary blade 20 relative to the moving blade, while also allowing the rotation of the selector ring 96 and the sliding movement of the toothed ring 72 along the splined shaft 64 between the locked and unlocked positions as described above.

While a particular embodiment of the present hair clipper having blade offset adjustment has been described herein, it will be appreciated by those skilled in the art that changes and modifications may be made thereto without departing from the invention in its broader aspects and as set forth in the following claims.

1. An adjustable bladeset for a hair clipper having a clipper housing, said bladeset comprising:
a stationary blade having a stationary toothed end with a plurality of stationary teeth, an opposite stationary base end and an upper surface;
a moving blade having a moving toothed end with a plurality of moving teeth, said moving blade configured for reciprocal transverse movement relative to said stationary blade on said upper surface;
said stationary blade being linearly displaceable relative to said moving blade by action of an adjustment lever associated with the clipper housing;
a blade guide associated with said upper surface and located on said stationary base end, said blade guide having at least one toothed strip; and
the adjustment lever connected to a blade actuator shaft having at least one toothed cog configured to engage said toothed strip so that rotation of said actuator shaft causes said linear displacement of said stationary blade relative to said moving blade.

2. The adjustable hair clipper bladeset of claim 1, wherein rotation of said actuator shaft between a locked position and an unlocked position causes movement of said stationary blade from an extended position to a retracted position.

3. The adjustable hair clipper bladeset of claim 1, wherein said blade guide has a pair of said toothed strips in spaced parallel relationship, and said actuator shaft has a pair of said toothed cogs, each said cog arranged to engage an associated one of said toothed strips.

4. The adjustable hair clipper bladeset of claim 1, wherein said adjustment lever is connected to said blade actuator shaft for common rotation.

5. The adjustable hair clipper bladeset of claim 1, wherein said adjustment lever is provided with a selector knob configured for rotating between two positions, a locked position causing smooth lever movement, and an unlocked position causing indexed lever movement.

6. The adjustable hair clipper bladeset of claim 5, wherein said selector knob has a splined shaft projecting from said lever and engaging a splined bore on said actuator shaft, and a toothed ring associated with said knob has a splined bore for slidably engaging said splined shaft.

7. The adjustable hair clipper bladeset of claim 6, wherein said adjustment lever has a biasing element that biases said toothed ring on said splined shaft away from said selector knob.

8. The adjustable hair clipper bladeset of claim 7, wherein said selector knob has at least one finger projecting along the splined shaft, each said finger configured for grasping the toothed ring so that said biasing member is held between the toothed ring and the selector knob.

9. The adjustable hair clipper bladeset of claim 8, wherein said toothed ring has a radially enlarged flange configured for accommodating tips of each of said at least one finger.

10. The adjustable hair clipper bladeset of claim 8, wherein said selector knob is associated with said adjustment lever so that rotation of the selector knob relative to said adjustment lever between the locked and unlocked positions causes movement of the toothed ring along the splined shaft, in said locked position, said at least one finger pulls the toothed ring towards said adjustment lever, overcoming the force of the coiled spring, thus achieving smooth motion of the adjustment lever, and as said selector knob is rotated, said at least one finger moves down the splined shaft away from the adjustment lever, and places said toothed ring in biased engagement with a gear bushing fixed to the clipper housing, causing a clicking or indexed movement of said adjustment lever.

11. An adjustable bladeset for a hair clipper having a clipper housing, said bladeset comprising:
a stationary blade having a stationary toothed end with a plurality of stationary teeth, an opposite stationary base end and an upper surface;
a moving blade having a moving toothed end with a plurality of moving teeth, said moving blade configured for reciprocal transverse movement relative to said stationary blade on said upper surface;
said stationary blade being linearly displaceable relative to said moving blade by action of an adjustment lever associated with the clipper housing; and
said adjustment lever is provided with a selector knob with a selector ring configured for rotating between two positions, a locked position causing smooth lever movement, and an unlocked position causing indexed lever movement.

12. The adjustable hair clipper bladeset of claim 11, wherein said adjustment lever has a splined shaft projecting from said lever and engaging a splined bore on said actuator shaft, and a toothed ring associated with said knob has a splined bore for slidably engaging said splined shaft.

13. The adjustable hair clipper bladeset of claim 12, wherein said adjustment lever has a biasing member that biases said toothed ring on said splined shaft away from a handle on said adjustment lever.

14. The adjustable hair clipper bladeset of claim 13, wherein said selector ring has a cam and a plurality of fingers projecting from said cam along the splined shaft, each said finger configured for grasping the toothed ring so that said biasing member is held between the toothed ring and the selector ring.

15. The adjustable hair clipper bladeset of claim 12, further including a gear bushing affixed to said housing in registry with said splined shaft and having a toothed exterior surface selectively engageable by said toothed ring.

16. The adjustable hair clipper bladeset of claim 15, wherein said selector knob is associated with said adjustment lever so that rotation of the selector knob relative to said adjustment lever between the locked and unlocked positions causes movement of the toothed ring along the splined shaft, in said locked position, said at least one finger pulls the toothed ring backwards out of engagement with said gear bushing overcoming the force of the coiled spring, thus achieving smooth motion of the adjustment lever, and as said selector knob is rotated, said at least one finger moves down the splined shaft away from the adjustment lever, and place said toothed ring in biased engagement with said gear bushing, causing a clicking or indexed movement of said adjustment lever.

17. A hair clipper, comprising:
a clipper housing;
a clipper bladeset including a stationary blade having a stationary toothed end with a plurality of stationary teeth, an opposite stationary base end and an upper surface, and a moving blade having a moving toothed end with a plurality of moving teeth, said moving blade configured for reciprocal transverse movement relative to said stationary blade on said upper surface;
said stationary blade being linearly displaceable relative to said moving blade by action of an adjustment lever associated with said clipper housing; and
said adjustment lever is provided with a selector knob configured for rotating between two positions, a locked position causing smooth lever movement, and an unlocked position causing indexed lever movement.

18. The hair clipper of claim 17, wherein said adjustment lever has a splined shaft projecting from said lever and engaging a splined bore on said actuator shaft, and a toothed ring associated with said knob has a splined bore for slidably engaging said splined shaft.

19. The hair clipper of claim 18, wherein said adjustment lever has a biasing member that biases said toothed ring on said splined shaft away from a handle on said adjustment lever, said selector knob has a cam and a plurality of fingers projecting from said cam along the splined shaft, each said finger configured for grasping the toothed ring so that said biasing member is held between the toothed ring and the selector knob.

20. The hair clipper of claim 19, further including a gear bushing affixed to said housing in registry with said splined shaft and having a toothed exterior surface selectively engageable by said toothed ring.

21. The hair clipper of claim 20, wherein said selector knob is associated with said adjustment lever so that rotation of the selector knob relative to said adjustment lever between the locked and unlocked positions causes movement of the toothed ring along the splined shaft, in said locked position, said at least one finger pulls the toothed ring backwards out of engagement with said gear bushing overcoming the force of the coiled spring, thus achieving smooth motion of the adjustment lever, and as said selector knob is rotated, said at least one finger moves down the splined shaft away from the adjustment lever, and place said toothed ring in biased engagement with said gear bushing, causing a clicking or indexed movement of said adjustment lever.

22. The hair clipper of claim 17, further including a blade guide associated with said upper surface and located on said stationary base end, said blade guide having at least one toothed strip; and
the adjustment lever connected to a blade actuator shaft having at least one toothed cog configured to engage said toothed strip so that rotation of said actuator shaft causes said linear displacement of said stationary blade relative to said moving blade.
